(19) United States
(12) Patent Application Publication
(10) Pub. No.: US 2026/0160332 A1
(43) Pub. Date: Jun. 11, 2026

(54) BANDING CLIP SEAL COVER

(71) Applicant: Graham BRIGHAM, Sherwood Park (CA)

(72) Inventor: Graham BRIGHAM, Sherwood Park (CA)

(21) Appl. No.: 19/406,215

(22) Filed: Dec. 2, 2025

(30) Foreign Application Priority Data
Dec. 9, 2024 (CA) 3258911

(51) Int. Cl. F16J 15/00; B65D 63/00

(52) U.S. Cl. CPC F16J 15/00; B65D 63/00

(57) ABSTRACT

A banding clip seal cover is provided that has a body that is placed over a banding clip and held in position to cover the banding clip. The body has a front face, a rear face, a first side wall, and a second side wall. The first side wall and the second side wall connect the front face to the rear face. At least a portion of one of the front face, the rear face, the first side wall, or the second side wall is flexible. The rear face has an aperture extending to a bottom of the rear face to allow placement over the banding clip.

### FIELD OF THE DISCLOSURE

The present application relates generally to a banding clip seal cover.

### BACKGROUND

This section provides background information to facilitate a better understanding of the various aspects of the invention. It should be understood that the statements in this section of this document are to be read in this light, and not as admissions of prior art.

When installing insulation and cladding around pipes, it is common to utilize banding straps. Banding clips are generally strips of metal that can be crimped around a banding strap. Banding clips may be strips of metal with flaps that are folded in towards or over each other or they may be more complex and appear as buckles where a portion of the metal is formed into a closed sleeve and a second portion has arms that are folded towards or over each other when the banding clips are engaged. When used, it is common for sharp edges, points, or other metal protrusions from the banding clips to exist. This commonly leads to injuries, damages clothing, and damaged materials surrounding the cladding. Injuries and damaged materials can be costly and cause delays on work sites.

### BRIEF SUMMARY

There is provided a banding clip seal cover that has a body that is placed over a banding clip and held in position to cover the banding clip. The body has a front face, a rear face, a first side wall, and a second side wall. The first side wall and the second side wall connect the front face to the rear face such that the front face and the rear face are spaced from each other. The rear face has an aperture that extends to a bottom of the rear face to allow the body to be placed over the banding clip seal. At least a portion of one of the front face, the rear face, the first side wall, and the second side wall is flexible.

In one embodiment, each of the front face, the rear face, the first side wall and the second side wall are flexible.

In another embodiment, the rear face is flexible.

In another embodiment, the first side wall and the second side wall are flexible.

In one embodiment, the body is held in position by the first side wall, the second side wall, and the rear face.

In one embodiment, the body further comprises a top face that extends from the front face to the rear face.

In one embodiment, the top face is flexible.

In one embodiment, the top face has a downwards extending tongue spaced from the front face and the rear face.

In one embodiment, the downwards extending tongue slidingly engages between the banding strap and the banding clip seal to hold the body in position to cover the banding clip.

In another embodiment, the downwards extending tongue acts as a guide to assist in positioning the body to cover the banding clip.

In one embodiment, the downwards extending tongue is flexible.

In a further embodiment, a bottom face is provided that extends from the front face to the rear face. The bottom face has an aperture sized to accommodate the banding clip such that the body is slidable over the banding clip from above or below the banding clip.

In one embodiment, the bottom face is flexible.

There is also provided a banding clip seal cover that has a body with a front face and a top face. The top face extends perpendicular to the front face. A downwards extending tongue extends from the top face such that the front face is spaced apart from the downwards extending tongue. The downwards extending tongue is positionable between a banding clip and a banding strap such that the front face of the body covers the banding clip.

In one embodiment, the body further comprises a first side wall and a second side wall. The first side wall and the second side wall extend from the front face and are angled towards the downwards extending tongue. The first side wall and the second side wall being adapted to cover the sides of the banding clip seal when the front face of the body covers the banding clip.

In one embodiment, the body further comprises a rear face. The top face, first side wall, and second side wall connect the front face to the rear face such that the front face is spaced from the rear face and the downwards extending tongue is spaced from the front face and the rear face. At least a portion of one of the front face, the rear face, the first side wall or the second side wall is flexible. The rear face has an aperture extending to a bottom of the rear face to allow the body to be placed over the banding clip and held in position to cover the banding clip.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a front perspective view of a banding clip seal cover.

FIG. 2 is a rear perspective view of the banding clip seal cover.

FIG. 3 is a front plan view of the banding clip seal cover.

FIG. 4 is a rear plan view of the banding clip seal cover.

FIG. 5 is side elevation view of the banding clip seal cover.

FIG. 6 is bottom plan view of the banding clip seal cover.

FIG. 7 is a top plan view of the banding clip seal cover.

FIG. 8 is a perspective view of a banding strap with banding clip.

FIG. 9 is a perspective view of the banding clip partially covered by the banding clip seal cover.

FIG. 10 is a perspective view of the banding clip cover covering the banding clip seal.

### DETAILED DESCRIPTION OF THE PREFERRED EMBODIMENTS

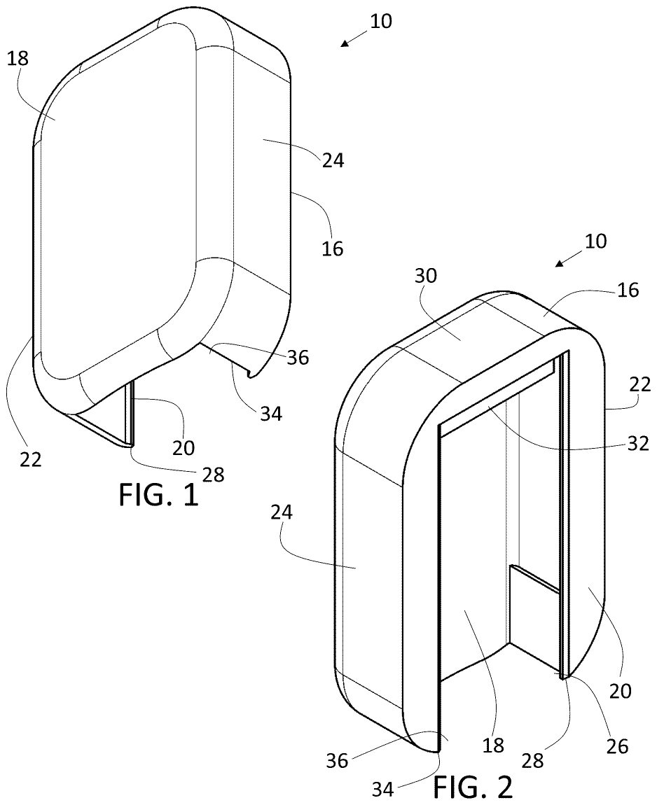

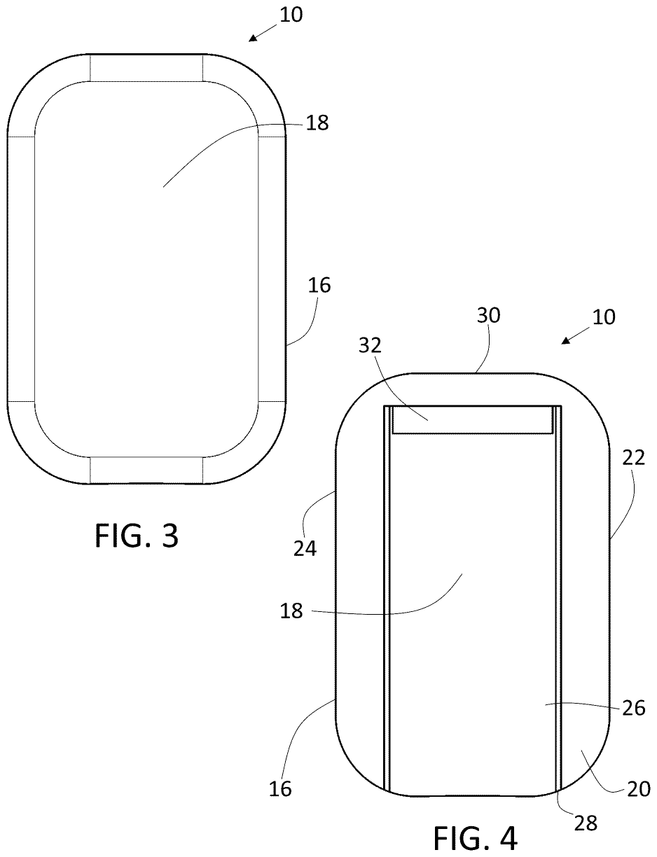

A banding clip seal cover, generally identified by reference numeral 10, will now be described with reference to FIG. 1 through FIG. 10.

Referring to FIG. 9, banding clip seal cover 10 is used to cover a banding clip 12 used to secure a banding strap 14 when the banding strap 14 is in use. In the embodiment shown, banding strap 14 is used to secure an outer cladding 16 around a pipe insulation system, however it will be understood by a person skilled in the art that banding straps 14, banding clips 12, and banding clip seal covers 10 may be utilized in any situation where a banding strap 14 with banding clip 12 is used.

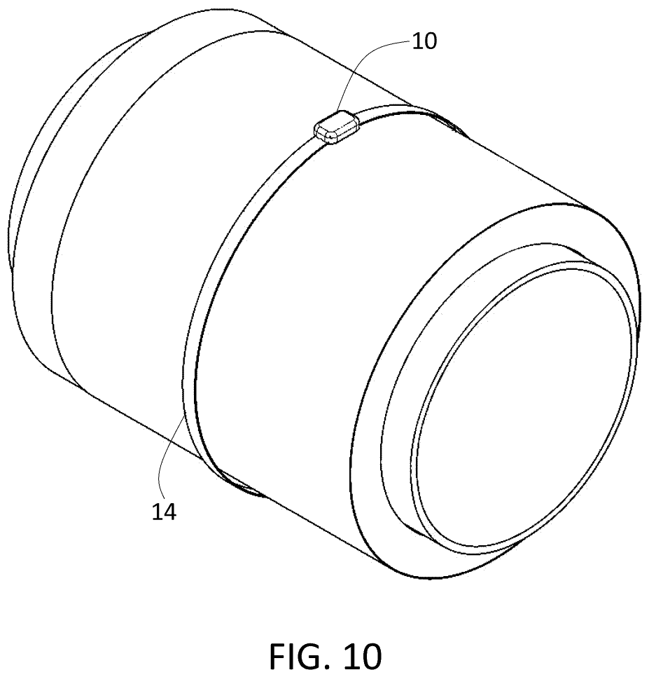

Referring to FIG. 1, banding clip seal cover 10 is a body 16 that has a front face 18, a rear face 20, a first side wall 22, and a second side wall 24. First side wall 22 and second side wall connect front face 18 to rear face 20 such the front face 18 is spaced from rear face 20. Referring to FIG. 2, rear face 20 has an aperture 26 that extends to a bottom 28 of rear face 20 to allow body 16 to be placed over a banding clip 12, shown in FIG. 9, and hold body 16 in position to cover banding clip seal, shown in FIG. 10. It will be understood by a person skilled in the art that the size of aperture 26 may vary depending upon the diameter of banding strap 14 and banding clip 12 being used. In addition, a person of skill should understand that rear face 20 may resemble a lip extending from first side wall 22, second side wall 24, or both first side wall 22 and second side wall 24 or may be more substantial in surface area. The purpose of rear face 20 is to provide a point of contact between body 16 and banding strap 14 and banding clip 12. Rear face 20 aids in maintaining the positioning of body 16 to cover banding clip 12. At least a portion of one of front face 18, rear face 20, first side wall 22, or second side wall 24 is flexible. Flexibility of at least a portion of body 16 allows for body 16 to give and flex around banding clip 12 while body 16 is being positioned over banding clip 12 without body 16 being damaged. It also allows body 16 to accommodate for the different shapes of banding clip 12 that can be expected when using banding clips 12.

The parts of body 16 that are made flexible may differ depending upon the specific environments or type of installations banding clip seal cover 10 are used with. In one embodiment, the entirety of body 16 is made of flexible material. In another embodiment, the front face 18, rear face 20, first side wall 22, and second side wall 24 are made of flexible material. In another embodiment, only rear face 20 is flexible. In a further embodiment, only first side wall 22 and second side wall 24 are made of flexible material. It will be understood by a person skilled in the art that different portions of body 16 may be made of flexible material and the embodiments described above should not be considered to limit what portions of body 16 and in what combinations flexible materials are used. Banding clip cover seal 10 may be made of any suitable material, including but not limited to metal, plastic, and rubber. Where metal is used, it is important that body 16 have smooth edges. Different portions of body 16 may be made of different materials.

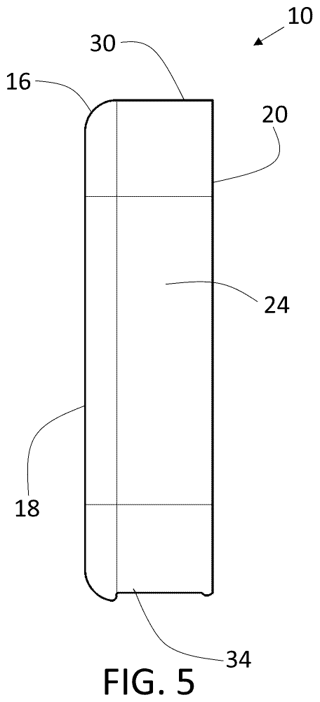

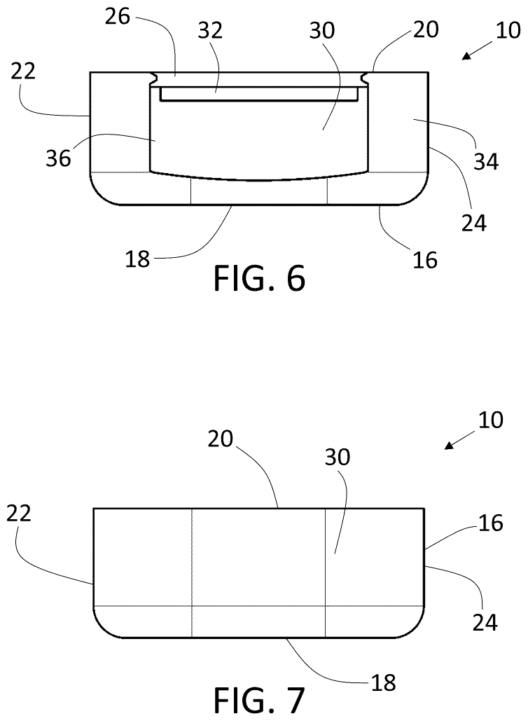

Referring to FIG. 5 and FIG. 7, body 16 has a top face 30 that extends from front face 18 to rear face 20. Top face 30 may be flexible. When rear face 20 is not present, top face 30 extends perpendicular relative to front face 18. Referring to FIG. 2, FIG. 4, and FIG. 6, a downwards extending tongue 32 extends from top face 30. Downwards extending tongue 32 slidingly engages between banding strap 14 and banding clip 12 and may be used to hold body 16 in position to cover banding clip 12 or as a guide for assisting in the positioning of body 16 when covering banding clip 12. When correctly positioned between banding strap 14 and banding clip 12, resistance to further movement of body 16 relative to banding strap 14 and banding clip 12 will be felt by a user. It will be understood that the length of downwards extending tongue 32 may vary.

In the embodiment shown in FIG. 6, a bottom face 34 may be included that extends from front face 18 to rear face 20. Bottom face 34 has an aperture 36 sized to accommodate banding clip 12 such that body 16 is slidable over banding clip 12 from above or below banding clip 12. Bottom face 34 may be flexible and may provide an additional point of contact between banding clip seal cover 10 and banding clip 12 or banding strap 14.

In another embodiment, in situations where it is challenging or impossible to have rear face 20 contact the underside of banding clip 12, rear face 20 may not be required and downwards extending tongue 32 may act to hold body 16 in position to cover banding clip 12. First side wall 22 and second side wall 24 provide additional coverage and help prevent body 16 from moving sideways relative to banding clip 12 when front face 18 is positioned to cover banding clip 12, however it will be understood by a person skilled in the art that only front face 18 is required to provide coverage.

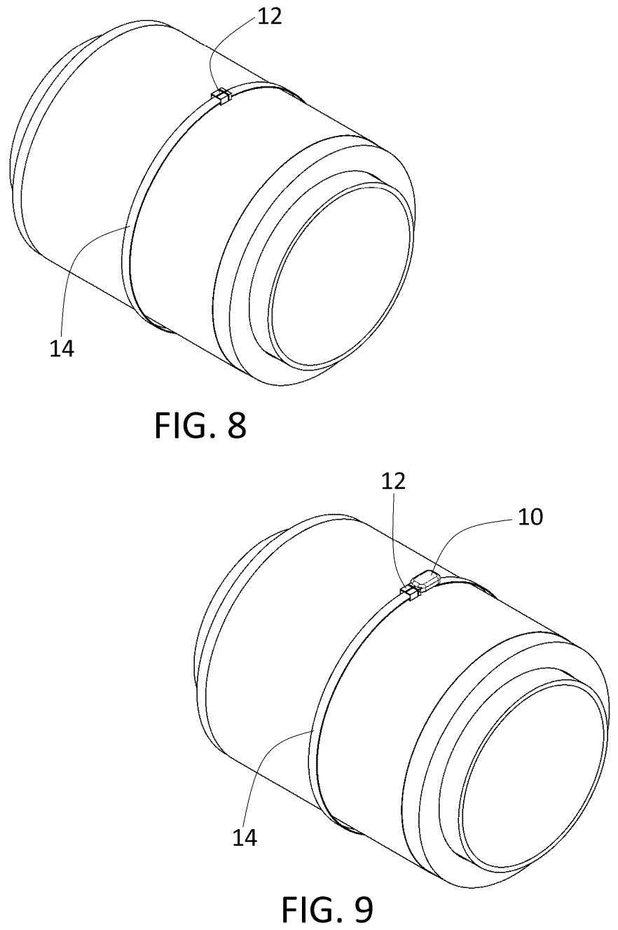

Referring to FIG. 8, when in use, body 16 is placed into contact with banding strap 14 above or below banding clip 12 such that rear body 20 contacts banding strap 14 and bottom 28 with aperture 26 is closer to banding clip 12 than top face 30, if top face is present, or a top of body 16. When bottom face 34 is present, aperture 36 of bottom face 34 is positioned closest to banding clip 12. In the embodiment shown, body 16 is placed above branding clip 12, however it will be understood by a person skilled in the art that body 16 may be positioned below banding clip 12. Positioning body 16 above banding clip 12 is preferred when top face 30 is present as top face 30 may prevent body 16 from sliding downwards off of banding clip 12. Referring to FIG. 9, body 16 is pushed downwards such that it begins to slide over banding clip 12. A user may need to flex body 16 to ensure that rear face 20 is making contact with the underside of banding clip 12 or adjacent the underside of banding clip 12. While it is preferable for body 16 to encompass the entire front of banding clip 12 plus a portion of the underside of banding clip 12, it should be understood that it is not always possible for rear face 20 to make contact with underside of banding clip 12 when banding strap 14 is too tight to allow for rear face 20 to slide under banding clip 12. Referring to FIG. 10, once banding clip 12 is covered by body 16, the user should ensure that contact between rear face 20 and underside of banding clip 12 or adjacent the underside of banding clip 12 is maintained. If it is not, portions of body 16 should be flexed to adjust the positioning. When downwards extending tongue 32 is present, a user will feel resistance to continued pushing movement after engagement of downwards extending tongue 32 between banding strap 14 and banding clip 12 and body 16 will not be easily pulled upwards without disengaging downwards extending tongue 32.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A banding clip seal cover, comprising:
a body having a front face, a rear face, a first side wall and a second side wall, the first side wall and the second side wall connecting the front face to the rear face such that the front face is spaced from the rear face, at least a portion of one of the front face, the rear face, the first side wall or the second side wall being flexible;
the rear face having an aperture extending to a bottom of the rear face to allow the body to be placed over a banding clip and held in position to cover the banding clip.

2. The banding clip seal cover of claim 1 wherein each of the front face, the rear face, the first side wall and the second side wall are flexible.

3. The banding clip seal cover of claim 1 wherein the rear face is flexible.

4. The banding clip seal cover of claim 1 wherein the first side wall and the second side wall are flexible.

5. The banding clip seal cover of claim 1 wherein the body is held in position by the first side wall, the second side wall, and the rear face.

6. The banding clip seal cover of claim 1 further comprising a top face extending from the front face to the rear face.

7. The banding clip seal cover of claim 6 wherein the top face is flexible.

8. The banding clip seal cover of claim 6 wherein the top face has a downwards extending tongue spaced from the front face and the rear face.

9. The banding clip seal cover of claim 8 wherein the downwards extending tongue slidingly engaging between a banding strap and the banding clip to hold the body in position to cover the banding clip.

10. The banding clip seal cover of claim 8 wherein the downwards extending tongue acts as a guide to assist in positioning the body to cover the banding clip.

11. The banding clip seal cover of claim 8 wherein the downwards extending tongue is flexible.

12. The banding clip seal cover of claim 1 further comprising a bottom face extending from the front face to the rear face, the bottom face having an aperture sized to accommodate the banding clip such that the body is slidable over the banding clip from above or below the banding clip.

13. The banding clip seal cover of claim 12 wherein the bottom face is flexible.

14. A banding clip seal cover, comprising:
a body having a front face and a top face, the top face extending perpendicular to front face;
a downwards extending tongue extending from the top face such that the front face is spaced apart from the downwards extending tongue;
the downwards extending tongue being positionable between a banding clip seal and a banding strap such that the front face of the body covers the banding clip.

15. The banding clip seal cover of claim 14 wherein the body further comprises a first side wall and a second side wall, the first side wall and the second side wall extending from the front face and being angled towards the downwards extending tongue, the first side wall and the second side wall being adapted to cover the sides of the banding clip when the front face of the body covers the banding clip.

16. The banding clip seal cover of claim 15 wherein the body further comprises a rear face, the top face, the first side wall and the second side wall connecting the front face to the rear face such that the front face is spaced from the rear face and the downwards extending tongue is spaced from the rear face and the front face, at least a portion of one of the front face, the rear face, the first side wall or the second side wall being flexible, the rear face having an aperture extending to a bottom of the rear face to allow the body to be placed over the banding clip and held in position to cover the banding clip.
